(19) United States
(12) Patent Application Publication
(10) Pub. No.: US 2019/0233701 A1
(43) Pub. Date: Aug. 1, 2019

(54) HEAT TRANSFER NANOCOMPOSITE MATERIAL

(71) Applicant: FUNDACIÓN CENTRO DE INVESTIGACIÓN COOPERATIVA DE ENERGÍAS ALTERNATIVAS CIC ENE, Vitoria-Gasteiz, Álava (ES)

(72) Inventors: Mani KARTHIK, Vitoria-Gasteiz, Álava (ES); Bruno D' AGUANNO, Vitoria-Gasteiz, Álava (ES); Abdessamad FAIK, Vitoria-Gasteiz, Álava (ES)

(21) Appl. No.: 16/338,254

(22) PCT Filed: Sep. 29, 2017
(86) PCT No.: PCT/EP2017/074843

§ 371 Date: Mar. 29, 2019

(30) Foreign Application Priority Data
Sep. 30, 2016 (EP) 16382451.9

(51) Int. Cl. C09K 5/12

(52) U.S. Cl. CPC C09K 5/12

(57) ABSTRACT

A nanocomposite material has a nanoporous material and a base heat transfer fluid confined within the pores of the nanoporous material. A method for preparing the nanocomposite material is provided. The nanocomposite material can be used as high temperature fluid. A thermal energy storage unit having the nanocomposite material is provided.

### FIELD OF THE INVENTION

The present invention relates to the field of heat transfer fluids and, more particularly, to the field of heat transfer nanofluids.

### BACKGROUND

The world energy crisis has triggered more attention to energy saving and energy conversion systems with high efficiency. There is a growing awareness that nanoscience and nanotechnology can have a profound impact on energy generation, conversion, and recovery. Nanotechnology-based solutions are being developed for a wide range of energy problems such as, solar electricity, hydrogen generation and storage, batteries, fuel cells, heat pumps and thermoelectrics. Recent advances in nanotechnology have led to the development of an innovative class of heat transfer fluids (nanofluids) created by dispersing nanoparticles (i.e. nanoparticles, nanofibers, nanotubes, nanowires, nanorods, nanosheet, or droplets) in traditional heat transfer fluids for various potential applications (S.U.S. Choi, ASME FED, 1995, 231, 99-103). In other words, nanofluids are nanoscale colloidal suspensions containing condensed nanomaterials. They are two-phase systems with one phase (solid phase) in another (liquid phase). Nanofluids have been found to possess enhanced thermophysical properties such as thermal conductivity, thermal diffusivity, heat capacity, and convective heat transfer coefficients compared to those of base fluids. Thus, they have been demonstrated having great potential applications in many research fields.

A significant amount of research has been conducted on nanofluids in last decades (R. S. Vajjha et al., Int. J. Heat Mass Transfer, 2012, 55, 4063-4078; I. M. Shahrul et al., Adv. Mater. Res. 2014, 832, 154-159) including preparation, characterization, modeling, convective and heat transfer and applications (Y. Xuan et al., J. Heat Transfer, 2003, 125, 151-155; S. Kakac et al., Int. J. Heat Mass Transfer, 2009, 52, 3187-3196; D. Wen et al., Int. J. Heat Mass Transfer, 2004, 47, 5181-5188; L. S. Sundar et al., Int. J. Heat Mass Transfer, 2010, 53, 4280-4286; D. W. Zhou et al., Int. J. Heat Mass Transfer, 2004, 47, 3109-3117; I. M. Mahbubul et al., Eng e-Trans, 2011, 6,124-130; H. Peng et al., Int J. Refrig., 2009, 32, 1756-1764). But most of the reports on nanofluids have mainly focused on low-temperature applications (E. Firouzfar et al., Appl. Therm. Eng., 2011, 31, 1543-1545; I. M. Shahrul et al., J Chem. Eng Jpn, 2014, 47, 340-344). Moreover, those studies on nanofluids have emphasized on thermal conductivity enhancement (J-Y. Jung et al., Int. J. Heat Mass Transfer, 2011, 54, 1728-1733; S. Lee et al.; J. Heat Transfer, 1999, 121, 280-289; S. M. S. Murshed et al., Int. J. Therm. Sci., 2005, 44, 367-373) and viscosity (I. M. Mahbubul et al., Int. J. Mech. Mater. Eng., 2012, 7, 146-151; P. Namburu et al., Exp. Therm. Fluid Sci., 2007, 32, 397-402; C. Nguyen et al., Int. J. Therm. Sci., 2008, 47, 103-111) but other thermophysical properties, such as the specific heat capacity which is of great importance for energy storage applications, are neglected (I. M. Shahrul et al., Numer. Heat Transfer, Part A. 2013, 65, 699-713).

Furthermore, very few reports are available for medium and high temperature thermal energy storage (TES) applications by using nanofluids. In addition, only few studies described enhancement in thermal conductivity and specific heat of fluids like molten salts doped with small amount of nanoparticles (M. Chieruzzi et al., Nanoscale Research Letters, 2013, 8, 448; D. Bharath et al., Int. J. Thermal Sci., 2013, 69, 37-42; H. Tiznobaik et al., Int. J. Heat and Mass Transfer, 2013, 57, 542-548; S. Donghyun et al., J. Heat Transfer, 2013, 135, 032801; M. Xi. Ho et al., Int. J. Heat and Mass Transfer, 2014, 70, 174-184). Moreover, US patent application U.S. Pat. No. 9,080,089 B2 describes silica coated zinc nanoparticles dispersed within an alkali chloride salt fluid. German patent application DE 102011083735 A1 describes a binary mixture of inorganic nitrate salts (in particular NaNO₃ and KNO₃) for the storage of thermal energy and as heat transfer fluid, for example within concentrated solar power (CSP) plants. Finally, Chinese patent application CN 104559941 A1 describes nitrate molten salts doped with nanoparticles in order to improve the specific heat capacity of the nitrate molten salts.

In view of the above, there is still the necessity of developing new nanofluid-based materials having enhanced specific heat capacity for high temperature energy storage applications.

### BRIEF DESCRIPTION OF THE INVENTION

The authors of the present invention have surprisingly found that the confinement of a heat transfer fluid within the pores of a nanoporous material can drastically increase the specific heat capacity of the base heat transfer fluid. Indeed, only a low weight percentage of the nanoporous material is necessary to enhance the specific heat capacity of the base heat transfer fluid.

Therefore, in a first aspect, the invention is directed to a nanocomposite material comprising:
from 0.5 wt % to 5 wt % of a nanoporous material with a pore size distribution from 0.5 to 50 nm; and
from 95 wt % to 99.5 wt % of a base heat transfer fluid confined within the pores of the nanoporous material;
   wherein the wt % are given on the basis of the total weight of the nanocomposite material.

The nanocomposite material of the present invention is prepared by a simple method based on melting diffusion.

Therefore, in a second aspect, the invention is directed to a method for preparing the nanocomposite material as defined above, comprising the steps of:

i) mixing from 0.5 wt % to 5 wt % of a nanoporous material with 95 wt % to 99.5 wt % of a base heat transfer fluid; and

ii) melting the mixture resulting from step (i) at a temperature above the liquidus temperature of the base heat transfer fluid.

The authors of the present invention have found that the nanocomposite material obtainable by the method as defined above present a specific heat capacity from 25% to 30% higher than the base heat transfer fluid.

Thus, in another aspect, the invention refers to a nanocomposite material obtainable by the method as defined above. These nanocomposite materials are fluids, and more specifically are dispersions. The present invention is therefore also directed to such fluids or dispersions in additional aspects.

Furthermore, the nanocomposite material of the present invention having enhanced specific heat capacity can be considered as a potential material for several thermal applications.

Therefore, in another aspect, the invention is directed to the use of the nanocomposite material as defined above as heat transfer fluid.

A final aspect of the invention refers to a thermal energy storage unit comprising the nanocomposite material as defined above.

### FIGURES

FIG. 1: Specific heat capacity versus temperature for solar salt and nanoporous material mixture.

FIG. 2: Specific heat capacity enhancement with respect of various nanoporous material contents.

FIG. 3: ATR Spectra of the salt based composites.

FIG. 4: XPS Spectra of salt based composites (salt+2 wt % of Al—Si-M-MCM-41 and salt+5 Wt % Al—Si-M-MCM-41).

FIG. 5: XPS spectra of salt based composite (salt+5 wt % M-MCM-41).

FIG. 6: TEM images of Al—Si-MCM-41 and Al—Si-MCM-41+salt composite.

FIG. 7: Elemental mapping of 5 wt % Al—Si-MCM-41+salt composite.

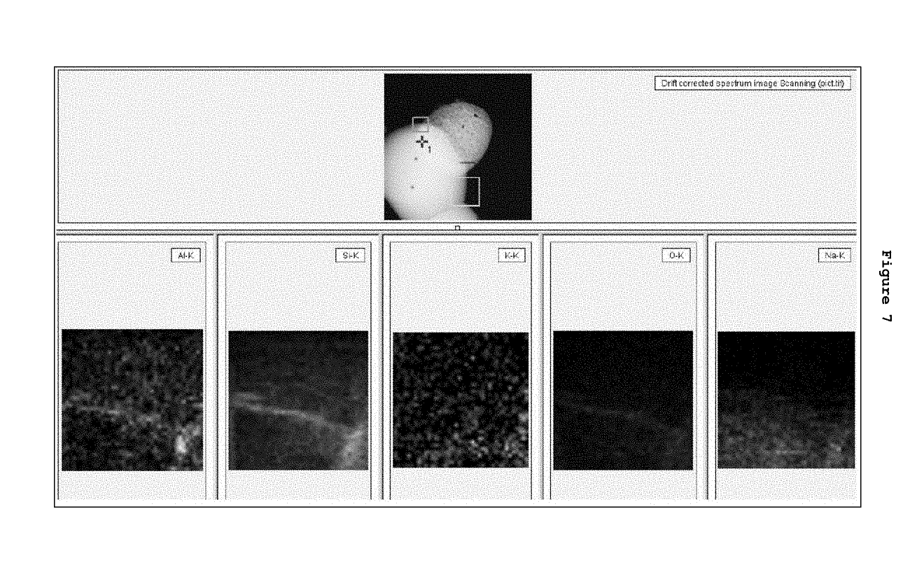

### DETAILED DESCRIPTION OF THE INVENTION

Unless defined otherwise, all technical and scientific terms used herein have the same meaning as commonly understood to one of ordinary skill in the art to which this disclosure belongs.

As defined above, in a first aspect, the present invention refers to a nanocomposite material comprising:
from 0.5 wt % to 5 wt % of a nanoporous material with a pore size distribution from 0.5 to 50 nm; and
from 95 wt % to 99.5 wt % of a base heat transfer fluid confined within the pores of the nanoporous material;
   wherein the wt % are given on the basis of the total weight of the nanocomposite material.

In the context of the present invention, the term “nanocomposite material” relates to a multiphase material where one of the phases has at least one dimension of less than 200 nm. In the present invention, the pores of the nanoporous material represent said dimension of less than 200 nm. In particular, the nanocomposite material of the present invention comprises a nanoporous material with a pore size distribution from 0.5 to 50 nm. In the context of the present invention, “nanoporous material” refers to an organic or inorganic framework supporting a nanoporous structure.

In an embodiment, the size of the nanoporous material particles in the nanocomposite material/fluid/dispersion of the invention ranges from 0.01 μm to 100 μm. Preferably, the size ranges from 0.1 μm to 50 μm, and more preferably from 0.5 μm to 45 μm, and even more preferably from 1 μm to 40 μm.

In an embodiment, the size of at least 50%, at least 70% or preferably at least 90% of the nanoporous material particles in the nanocomposite material/fluid/dispersion of the invention ranges from 0.5 μm to 20 μm, and more preferably from 1 μm to 10 μm.

In an embodiment, the average size of the nanoporous material particles in the nanocomposite material/fluid/dispersion of the invention ranges from 1 μm to μm, preferably from 3 μm to 4 μm. The average size is preferably calculated by randomly choosing 10, 50 or 100 particles and averaging their sizes. Sizes of individual particles can be calculated by techniques such as Transmission Electron Microscopy or Scanning Electron Microscopy.

In the context of the present invention, the term “pore size distribution” refers to a statistical distribution of the pore sizes present in a porous material and it can be determined by well-known methods by a skilled person such as gas adsorption, permoporometry, thermoporometry and mercury intrusion.

Non-limiting examples of nanoporous materials include metal-organic frameworks, aluminosilicates, silica and alumina as well as oxides of niobium, tantalum, titanium, zirconium, cerium and tin.

In a preferred embodiment, the nanoporous material is an aluminosilicate mineral.

The term “aluminosilicate” refers to silicates (composed by the silicon-oxygen (SiO₄)⁴⁻ tetrahedron as the fundamental unit) in which some of the ions are replaced by Al³⁺ ions. For each ion replaced by an Al³⁺, the charge must be balanced by having other positive ions such as Na⁺, K⁺, and Ca²⁺ ions.

Non-limiting examples of aluminosilicate are feldspars and zeolites.

In a preferred embodiment, the nanoporous material is a zeolite.

In the context of the present invention, the term “zeolite” refers to a natural or synthetic crystalline inorganic molecular sieve having a framework structure consisting of nanopores and interconnected cavities which can be occupied by chemical species. In contrast to amorphous materials, these crystalline structures contain regular arrays of intracrystalline pores (nanopores) and voids of uniform dimensions.

Non-limiting examples of natural zeolites suitable for the nanocomposite material as defined above includes the minerals Clinoptilolite (K₂, Na₂, Ca) 3Al₆Si₃₀O₇₂.21H₂O, Mordenite (Na₂, Ca) 4Al₈Si₄₀O₉₆.28H₂O, Chabazite (Ca, Na₂, K₂) 2Al₄Si₈O₂₄.12H₂O, Phillipsite K₂ (Ca, Na₂) 2Al₈Si₁₀O₃₂.12H₂O, Scolecite Ca₄Al₈Si₁₂O₄₀.12H₂O, Stilbite Na₂Ca₄Al₁₀Si₂₆O₇₂.30H₂O, Analcime Na₁₆Al₁₆Si₃₂O₉₆.16H₂O, Laumontite Ca₄Al₈Si₁₆O₄₈.16H₂O, Erionite (Na₂K₂MgCa_{1.5}) 4Al₈Si₂₈O₇₂.28H₂O and Ferrierite (Na₂, K₂, Ca, Mg) 3Al₆Si₃₀O₇₂.20H₂O.

In an embodiment, the zeolite is present in its hidrated form. In a preferred embodiment, the zeolite is present in its anhydrous form.

Non-limiting examples of synthetic zeolites suitable for the nanocomposite material as defined above includes zeolites of type A, 5A, beta, mordenite, Y, MCM-41, MCM-48, MCM-50, M41S, FSM-16, 13X, NaP1 and ZSM-5.

In a preferred embodiment, the nanoporous material of the nanocomposite material as defined above is a zeolite, preferably a Y-zeolite, a Beta-zeolite, MCM-41-zeolite or a ZSM-5-zeolite.

Even in a more preferred embodiment, the nanoporous material of the nanocomposite material as defined above is a H—Y-zeolite, a Na—Y-zeolite or a Si-MCM-41-zeolite.

The authors of the present invention have surprisingly found that a low weight percentage of the nanoporous material is sufficient to drastically enhance the specific heat capacity of the base heat transfer fluid.

In the context of the present invention, the “weight percent” or “wt %” are given on the basis of the total weight of the nanocomposite material.

In particular, the nanocomposite material of the invention comprises from 0.5 wt % to 5 wt % of the nanoporous material as defined above, preferably between 0.5 wt % and 2 wt %.

Additionally, the nanocomposite of the present invention further comprises from 95 wt % to 99.5 wt % of a base heat transfer fluid as defined above, preferably between 98 wt % and 99.5 wt %.

In the context of the present invention, the term “heat transfer fluid” refers to a liquid used to transfer heat from one system to another, normally to another fluid.

In the nanocomposite material of the invention, the base heat transfer fluid is confined within the pores of the nanoporous material as defined above. In other words, the base heat transfer fluid, once molten, does not only serve to suspend the nanoporous material but part of said base heat transfer fluid also penetrates and resides inside the pores of said nanoporous material.

Without being bound to any theory in particular, the authors of the present invention believes that the nano-confinement of the base heat transfer fluid in the nanoporous material profoundly influences its thermal properties due to strong interface interactions existing between the adsorbed molecules of the fluid and the pores walls of the nanoporous material. Indeed, it is thought that the heat transfer fluid within the nanopores may be in a heterogeneous state in the form of surface layer and inner layer, varying with fluid-wall interactions.

In a preferred embodiment, the base heat transfer fluid is a molten salt, more preferably a molten alkali metal salt.

In the context of the present invention, the term “molten salt” refers to a salt which is solid at standard temperature and pressure but enters the liquid phase due to elevated temperature.

Non-limiting examples of molten alkali metal salts include molten alkali metal nitrates, molten alkali metal carbonates, molten alkali metal chlorides, molten alkali metal fluorides and mixtures thereof.

In a preferred embodiment, the base heat transfer fluid of the nanocomposite as defined above is a mixture of molten alkali metal nitrate salts, preferably a mixture of NaNO₃ and KNO₃, more preferably a mixture of 60 wt % NaNO₃ and 40 wt % KNO₃.

On the other hand, the method of preparation of a nanofluid is a key factor for determining its specific heat capacity since it defines the level of particle agglomeration. Two techniques are mainly used in the state of the art for the preparation of nanofluids, i.e. single step methods and two steps methods. The two steps dispersion methods and ultrasonic vibrations are the most widely used for the proper mixtures of nanofluids in order to avoid as much as possible particle agglomeration.

In contrast, the nanocomposite material of the present invention is preferably prepared by a method based on melting diffusion of a base heat transfer fluid into the pores of a nanoporous material.

The term “melting diffusion” refers to a solid state synthesis method which consists starting from a physical mixture of two solids with different melting points. The solid with the lowest melting point is melt at an absolute temperature that is above its liquidus temperature. As a result, the melt solid diffuses into the solid with the higher melting point.

In particular, the nanocomposite material as defined above is prepared by a method comprising the steps of:

i) mixing between 0.5 wt % and 5 wt % of a nanoporous material with 95 wt % to 99.5 wt % of a base heat transfer fluid; and

ii) melting the mixture resulting from step (i) at a temperature above the liquidus temperature of the heat transfer fluid.

Thus, the method of preparation of the nanocomposite material as defined above comprises a first step (i) of mixing from 0.5 wt % to 5 wt % of a nanoporous material with 95 wt % to 99.5 wt % of a base heat transfer fluid.

In an embodiment, the nanocomposite material obtained after step ii) is allowed to solidify. The present invention thus also refers in an additional aspect to said solid. Embodiments described herein for the nanocomposite material are applicable to this solid. In this solid, the base heat transfer fluid remains confined in the pores of the nanoporous material. The solid form can be suitable for instance for storage of the nanocomposite material of the invention prior to its industrial use.

The step (i) of mixing the nanoporous material and the base heat transfer fluid could be performed by well-known methods in the technical field of the present invention such as grinding, milling or shaking.

The nanoporous material is chosen based on its composition, porosity and channel/pore size which helps controlling the heat transfer fluid loading.

In a preferred embodiment, the nanoporous material of step (i) is an aluminosilicate, preferably a zeolite.

Non-limiting examples of a natural zeolites suitable for the method as defined above includes the minerals Clinoptilolite (K₂, Na₂, Ca) 3Al₆Si₃₀O₇₂.21H₂O, Mordenite (Na₂, Ca) 4Al₈Si₄₀O₉₆.28H₂O, Chabazite (Ca, Na₂, K₂) 2Al₄Si₈O₂₄.12H₂O, Phillipsite K₂ (Ca, Na₂) 2Al₈Si₁₀O₃₂.12H₂O, Scolecite Ca₄Al₈Si₁₂O₄₀.12H₂O, Stilbite Na₂Ca₄Al₁₀Si₂₆O₇₂.30H₂O, Analcime Na₁₆Al₁₆Si₃₂O₉₆.16H₂O, Laumontite Ca₄Al₈Si₁₆O₄₈.16H₂O, Erionite (Na₂K₂MgCa_{1.5}) 4Al₈Si₂₈O₇₂.28H₂O and Ferrierite (Na₂, K₂, Ca, Mg) 3Al₆Si₃₀O₇₂.20H₂O.

In an embodiment, the zeolite added to the mixture of step i) is in its hydrated form. In a preferred embodiment, the zeolite added to the mixture of step i) is in its anhydrous form.

Non-limiting examples of synthetic zeolites suitable for the method as defined above includes zeolites of type A, 5A, beta, mordenite, Y, MCM-41, MCM-48, MCM-50, M41S, FSM-16, 13X, NaP1 and ZSM-5.

In a more preferred embodiment, the nanoporous material of the nanocomposite material as defined above is a zeolite, preferably a Y-zeolite, a Beta-zeolite, MCM-41-zeolite or a ZSM-5-zeolite.

Even in a more preferred embodiment, the nanoporous material of the nanocomposite material as defined above is a H—Y-zeolite, a Na—Y-zeolite or a Si-MCM-41-zeolite.

In another preferred embodiment, the base heat transfer fluid of step (i) is a salt, more preferably an alkali metal salt.

Non-limiting examples of alkali metal salts suitable for the method of the invention include alkali metal nitrates, alkali metal carbonates, alkali metal chlorides, alkali metal fluorides and mixtures thereof.

In a preferred embodiment, the base heat transfer fluid of step (i) is a mixture of alkali metal nitrate salts, preferably a mixture of NaNO₃ and KNO₃, more preferably a mixture of 60% NaNO₃ and 40 wt % KNO₃.

The method of preparation of the nanocomposite material as defined above further comprises a second step (ii) of melting the mixture resulting from step (i) at a temperature above the liquidus temperature of the heat transfer salt.

In the context of the present invention, the term “melting point” refers to the temperature generally determined by heating a sample at a controlled rate and using an optical method to record the temperature at which each mixture transitions from opaque to clear. This transition corresponds to the “liquidus temperature”, which is defined as the temperature during heating at which the last remaining solid phase melts and becomes liquid. The liquidus temperature is also equivalent to the temperature during cooling at which a solid phase first appears in the melt. A differential scanning calorimeter (DSC) can also be used to measure the melting point of a sample, as well as other relevant thermal properties including specific heat capacity.

In a preferred embodiment, the mixture resulting from step (i) is melt at a temperature above of its liquidus temperature.

The nanocomposite material obtainable by the method as defined above present a specific heat capacity between 25% and 30% higher than the base heat transfer fluid.

In the context of the present invention, the term “specific heat capacity” refers to the amount of heat needed to raise the temperature of one kilogram of a material by 1 kelvin.

Since thermal energy can be stored in a material by raising its temperature, the nanocomposite material of the present invention having enhanced specific heat capacity could be considered as having great potential for several thermal applications. For example, current research projects based on thermal energy storage rely on storage units in which thermal energy is transferred from a heat transfer fluid to a second fluid for storage that can be also the same heat transfer fluid.

Therefore, one aspect of the invention is directed to the use of the nanocomposite material as defined above as heat transfer fluid.

The nanocomposite material of the invention obtained by the method of the invention is a fluid, more specifically a dispersion, wherein the continuous phase is formed by the base heat transfer fluid and the nanoporous material is dispersed in said continuous phase.

In other words, what is obtained is a dispersion comprising:
as a dispersed phase: from 0.5 wt % to 5 wt % of a nanoporous material with a pore size distribution between 0.5 and 50 nm;
as the continuous phase: from 95 wt % to 99.5 wt % of a base heat transfer fluid;

wherein the wt % are given on the basis of the total weight of the dispersion.

In this dispersion, the base heat transfer fluid is confined within the pores of the nanoporous material.

It is to be understood that embodiments described above or uses referred to further below for the nanocomposite material of the invention are applicable to the fluid or dispersion of the invention.

Preferably, at least 70%, more preferably at least 80%, more preferably at least 90%, and most preferably at least 95% of the volume of the pores of the nanoporous material is filled by the base heat transfer fluid.

In a preferred embodiment, in any of the aspects or embodiments of the present invention, the nanoporous material is not sodium aluminate or lithium ferrite, and/or the base heat transfer fluid is not barium carbonate or strontium carbonate.

In another embodiment, the density of the nanoporous material is not lower than 2.0 g/cm³ and/or the density of the base heat transfer fluid is not greater than 3.4 g/cm³.

In another embodiment, in any of the aspects or embodiments of the present invention, the nanoporous material represents from 0.5% to 9.5% of the volume of the nanocomposite material/fluid/dispersion of the invention. Preferably, the nanoporous material represents from 0.5% to 9%, more preferably from 0.5% to 8%, more preferably from 0.5% to 5% of the volume of the nanocomposite material/fluid/dispersion of the invention. These volumes refer to real (skeletal) volumes and not apparent volumes. The volumes are the ones that each component occupies in the final volume of the nanocomposite material/fluid/dispersion after melting. Likewise, in any of the aspects or embodiments of the present invention, the base heat transfer fluid represents from 90.5 to 99.5% of the volume of the nanocomposite material/fluid/dispersion of the invention. Preferably, the base heat transfer fluid represents from 91 to 99.5%, more preferably from 92 to 99.5%, more preferably from 95 to 99.5% of the volume of the nanocomposite material/fluid/dispersion of the invention.

In another embodiment, in any of the aspects or embodiments of the present invention, the wt % of the nanoporous material is between 0.5 wt % and 2 wt %; and/or the wt % of the base heat transfer fluid is between 98 wt % and 99.5 wt %. Preferably, the wt % of the nanoporous material is between 0.5 wt % and 1.5 wt %; and/or the wt % of the base heat transfer fluid is between 98.5 wt % and 99.5 wt %. More preferably, the wt % of the nanoporous material is between 0.5 wt % and 0.9 wt %; and/or the wt % of the base heat transfer fluid is between 99.1 wt % and 99.5 wt %. Most preferably, the wt % of the nanoporous material is between 0.6 wt % and 0.7 wt %; and/or the wt % of the base heat transfer fluid is between 99.4 wt % and 99.3 wt %. These weights percentages are with respect to the total weight of the nanocomposite material/fluid/dispersion.

In another aspect, the invention refers to a thermal energy storage unit comprising the nanocomposite material as defined above.

Since the nanocomposite material of the present invention presents enhanced specific heat capacity which is proportional to its volume, it can significantly reduce the required amount of thermal energy storage medium, the size of thermal energy storage unit and consequently, the size of the corresponding thermal transport system. Hence, a large reduction in the total cost of thermal energy storage units is expected.

In the context of the present invention, the term “thermal energy storage unit” refers to a system comprising a pressurized storage vessel; a thermal energy storage media within the pressurized storage vessel; and a heat transfer fluid coupled to the pressurized storage vessel and in contact with the storage fluid to transfer heat energy between the storage fluid and a working fluid; wherein the storage fluid increases its temperature as the heat energy is transferred from the working fluid to the storage fluid and decreases its temperature as the heat energy is transferred from the storage fluid to the at least one working fluid.

### EXAMPLES

The present invention will now be described by way of examples which serve to illustrate the construction and testing of illustrative embodiments. However, it is understood that the present invention is not limited in any way to the examples below.

### Preparation of M-MCM-41-Based Nanocomposite Materials

Nanocomposite materials having different weight percentage (wt %) of nanoporous zeolite Si-MCM-41 and the corresponding amount of a heat transfer salt (solar salt formed by 60 wt % NaNO₃ and 40 wt % KNOB) were prepared by physically mixing both solids. The resulting mixture was melted at above the liquidus temperature (270° C.) of the heat transfer fluid for at least 4 hours and then cooled down to room temperature.

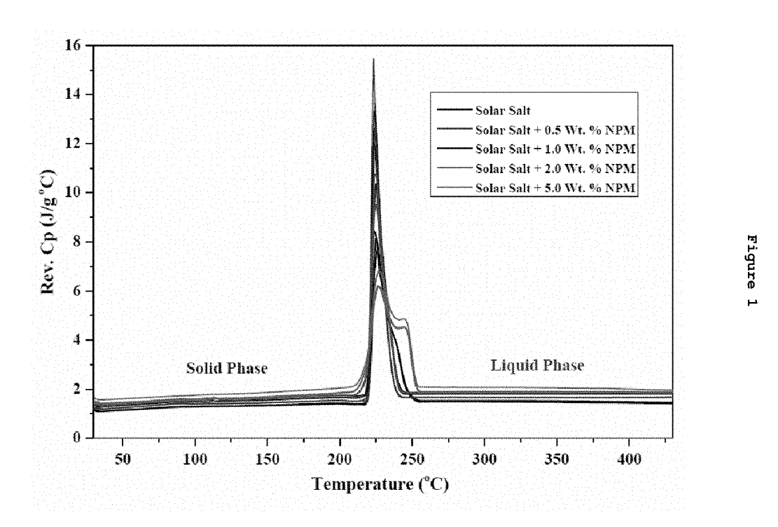

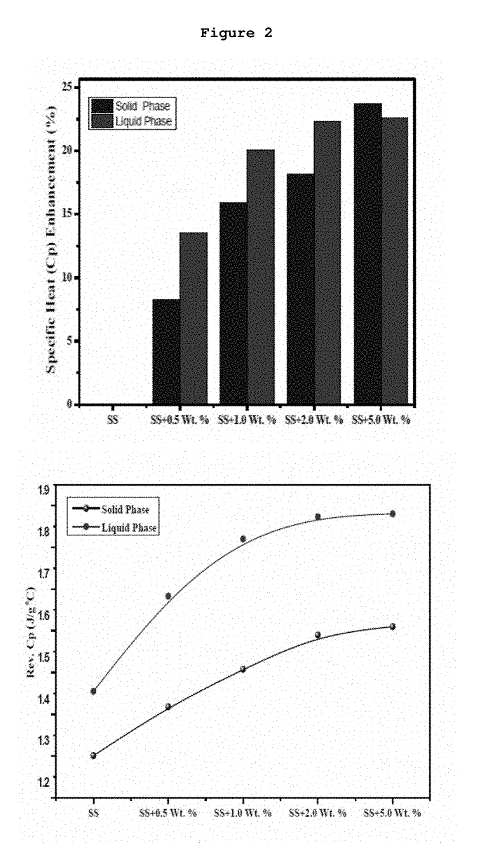

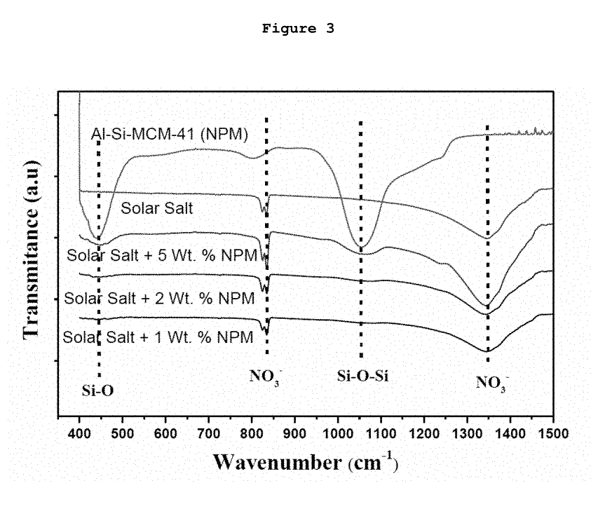

The specific heat capacities of the resulting nancomposoite materials were analyzed by using differential scanning calorimeter (DSC) as shown in FIGS. 1-2 and attenuated total reflectance (ATR) spectroscopy as shown in FIG. 3. Enhancement of the specific heat capacities was clearly observed, obtaining the maximum heat capacity for the nanocomposite material comprising 5 wt % of nanoporous zeolite Si-MCM-41.

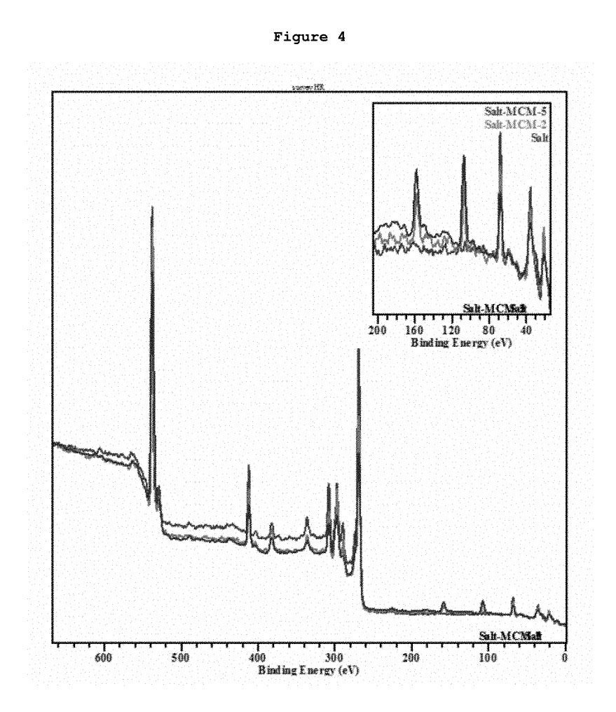

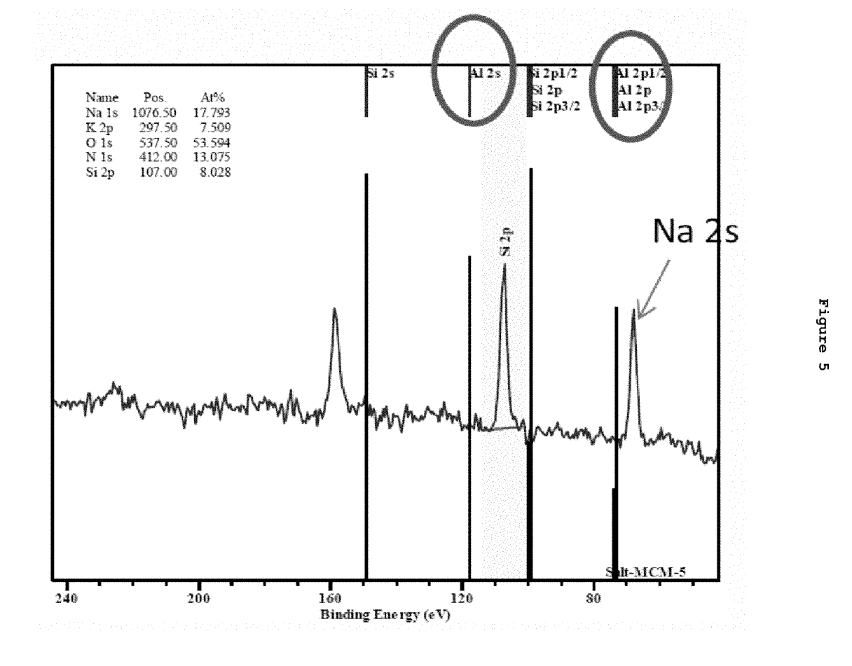

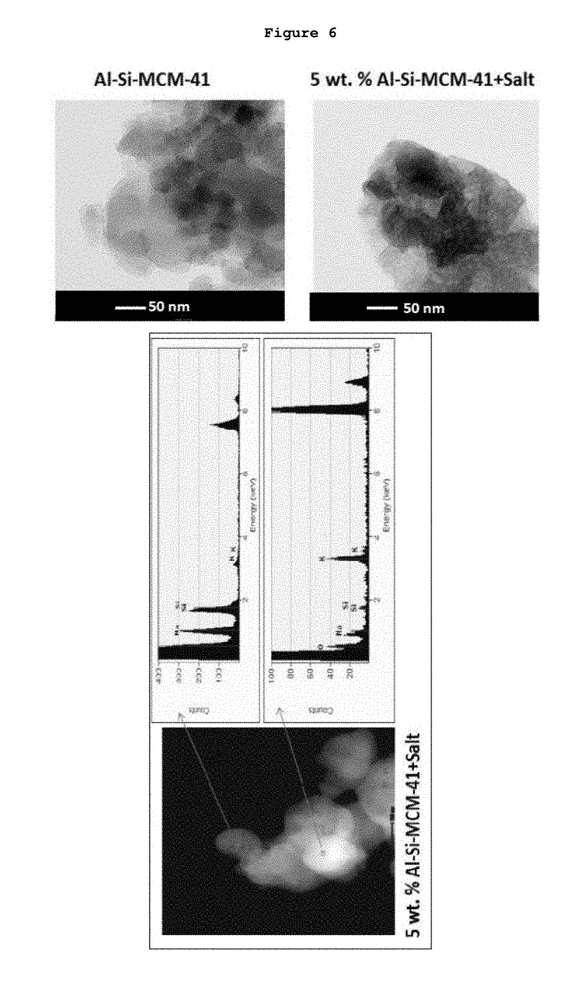

Their physico-chemical properties were also investigated and compared with the base heat transfer salt and the base nanoporous material by X-ray photoelectron spectroscopy (XPS), Transmission Electron Microscopy (TEM) and Elemental mapping shown in Tables 1 and 2 as well as FIGS. 4-6.

TABLE 1
XPS results of the salt based composites.
Relative concentrations, At %

| | | | salt + 2 wt % | salt + 5 wt % |
|---|---|---|---|---|
| Element | Salt | Si-MCM-41 | Si-MCM-41 | Si-MCM-41 |
| Na 1s | 22 | — | 16 | 18 |
| K 2p | 10 | — | 10 | 7 |
| O 1s | 51 | 60 | 51 | 54 |
| N 1s | 17 | — | 18 | 13 |
| Si 2p | — | 38 | 5 | 8 |
| Al 2p | — | 1.5 | 0 | 0 |

TABLE 2
XPS results of solar salt and solar salt + 5 Wt % NPM.

| | | | Auger |
|---|---|---|---|
| | Na 2p, eV | Na KVV, eV | parameter |
| Salt | 1076.6 | 268/984.8 | 2061.7 |
| Salt + 5 Wt % NPM | 1076.6 | 268.8/984.6 | 2061.2 |

Surface interaction of Si-MCM-41 with the salt was confirmed by XPS analysis and it was found that the (salt+5 wt % Si-MCM-41) nanocomposite material showed 0.5 eV (Auger parameter) less value as compared to that of pure salt.

Therefore, it was confirmed that the nano-confinement of the salt in the nanoporous material improves its thermal properties due to strong interactions existing between the adsorbed molecules of the salt and the pores walls of the nanoporous material.

1. A nanocomposite material comprising:
from 0.5 wt % to 5 wt % of a nanoporous material with a pore size distribution between 0.5 and 50 nm; and
from 95 wt % to 99.5 wt % of a base heat transfer fluid confined within the pores of the nanoporous material;
wherein the wt % are given on the basis of the total weight of the nanocomposite material.

2. The nanocomposite material according to claim 1, wherein:
the wt % of the nanoporous material is between 0.5 wt % and 2 wt %; and/or
the wt % of the base heat transfer fluid is between 98 wt % and 99.5 wt %.

3. The nanocomposite material according to claim 1, wherein the nanoporous material is an aluminosilicate.

4. The nanocomposite material according to claim 3, wherein the aluminosilicate is a zeolite.

5. The nanocomposite material according to claim 1, wherein the base heat transfer fluid is a molten alkali metal salt.

6. The nanocomposite material according to claim 1, in the form of a fluid.

7. The nanocomposite material according to claim 6, in the form of a dispersion.

8. A dispersion comprising:
as a dispersed phase: from 0.5 wt % to 5 wt % of a nanoporous material with a pore size distribution between 0.5 and 50 nm;
as the continuous phase: from 95 wt % to 99.5 wt % of a base heat transfer fluid;
wherein the base heat transfer fluid is confined within the pores of the nanoporous material; and wherein the wt % are given on the basis of the total weight of the dispersion.

9. A method for preparing the nanocomposite material according to claim 1, comprising the steps of:
i) mixing from 0.5 wt % to 5 wt % of a nanoporous material with 95 wt % to 99.5 wt % of a base heat transfer fluid; and
ii) melting the mixture resulting from step (i) at a temperature above the liquidus temperature of the heat transfer fluid.

10. The method according to claim 9, wherein the nanoporous material of step (i) is a zeolite.

11. The method according to claim 10, wherein the zeolite is selected from the group consisting of a Y-zeolite, a Beta-zeolite, MCM-41 zeolite, and a ZSM-5 zeolite.

12. The method according to claim 9, wherein the base heat transfer fluid is a salt.

13. The method according to claim 12, wherein the salt is an alkali metal salt.

14. The method according to claim 13, wherein the alkali salt is selected from the group consisting of alkali metal nitrates, alkali metal carbonates, alkali metal chlorides, alkali metal fluorides, and mixture thereof.

15. The method according to claim 9, wherein the base heat transfer fluid is a mixture of alkali metal nitrate salts.

16. The method according to claim 15, wherein the mixture of alkali metal nitrate salts is a mixture of NaNO₃ and KNO₃.

17. A nanocomposite material obtained by the method according to claim 9.

18. (canceled)

19. A thermal energy storage unit comprising the nanocomposite material according to claim 1.

20. A method for preparing the dispersion according to claim 8, comprising the steps of:
i) mixing from 0.5 wt % to 5 wt % of a nanoporous material with 95 wt % to 99.5 wt % of a base heat transfer fluid; and
ii) melting the mixture resulting from step (i) at a temperature above the liquidus temperature of the heat transfer fluid.

21. A thermal energy storage unit comprising the dispersion according to claim 8.
